(19) United States
(12) Patent Application Publication
(10) Pub. No.: US 2015/0317688 A1
(43) Pub. Date: Nov. 5, 2015

(54) OPTIMIZING A CONTENT CAMPAIGN TO ACHIEVE A DESIRED OBJECTIVE

(71) Applicant: Linkedln Corporation, Mountain View, CA (US)

(72) Inventors: Venkata S.J.R. Bhamidipati, Fremont, CA (US); Huining Feng, Cupertino, CA (US); Baoshi Yan, San Jose, CA (US); Yingfeng Oh, Cupertino, CA (US); Michael Grishaver, Portola Valley, CA (US)

(21) Appl. No.: 14/320,314

(22) Filed: Jun. 30, 2014

Related U.S. Application Data
(60) Provisional application No. 61/986,811, filed on Apr. 30, 2014.

(51) Int. Cl. G06Q 30/02; G06Q 50/00

(52) U.S. Cl. CPC G06Q 30/0269; G06Q 50/01

(57) ABSTRACT

Techniques to facilitate recommendations for sponsored content campaigns are described. Consistent with some embodiments, subsequent to a member of a social networking service specifying a desired objective to be achieved with a content campaign (e.g., increasing follower acquisition rate, or increasing a click-to-convert rate), a campaign optimization module provides, for a member-specified content posting, a recommended target audience that is most likely to react to the content posting in a manner that will enable the member to achieve the desired objective. Alternatively, a member may specify a desired objective and a target audience, and the campaign optimization module provides a recommendation as to the particular content posting that the member should promote or sponsor in order to achieve the desired objective.

### RELATED APPLICATIONS

The present application claims priority to U.S. Provisional Patent Application No. 61/986,811, filed on Apr. 30, 2014, entitled, OPTIMIZING A CONTENT CAMPAIGN TO ACHIEVE A DESIRED OBJECTIVE, which is hereby incorporated by reference in its entirety.

### TECHNICAL FIELD

The present disclosure generally relates to data processing systems. More specifically, the present disclosure relates to methods, systems and computer program products that facilitate the making of recommendations to members of a social networking application or service regarding content campaigns generally, and sponsored content campaigns in particular, where the recommendations are directed to enabling members to achieve one of several desired objectives with a content campaign.

### BACKGROUND

As social networking applications and services have proliferated, the content communication mechanism that is commonly referred to as a feed has also increased in complexity and popularity. In the context of social networking applications and services, a feed—also commonly referred to as a “newsfeed,” “content feed,” “stream,” “activity stream,” “content stream,” and/or “update stream”—is a content communication or publishing platform by which content publishers can publish or post content items for others to consume (e.g., view and/or hear). With some feeds, the content items that are presented to any particular member are content items that have been posted by a person, or on behalf of an entity (e.g., company, school, organization, etc.), to which the particular member has some association. For instance, with some feeds, the content selected for presentation to a particular member is content posted by other members with whom the particular member is connected, or, following.

As used herein, a “connection” is an explicitly defined, bi-lateral relationship that exists between two members of a social networking application or service. For example, two members are directly connected (e.g., first-degree connections) when each member has taken some explicit action to acknowledge an existing relationship with the other member. Second- and third-degree connections exist between two members where there is one intermediary member, in the case of a second-degree connection, or two intermediary members, in the case of a third-degree connection, connecting the two members. In contrast to the concept of a connection, a “following” relationship typically is a unilateral relationship. For instance, a first member can typically follow a second member without any explicit authorization by the second member. As such, the concept of “following” is similar to subscribing—that is, when a member “follows” another person or entity, the member is in essence subscribing to receive, in his or her feed, content that is posted by, or on behalf of, another person or entity. In any case, with many feeds, the content selected for presentation to a particular member is content that has been published by, or otherwise relates to, another member with whom the particular member is associated (e.g., connected or following).

As a member of a social networking service establishes more and more connections, and follows more and more people, companies, and other entities, the amount of content eligible for presentation in the member's feed increases. In fact, in many instances, the volume of content that may be eligible for presentation to a member far exceeds the practical amount of content that the member can reasonably consume (e.g., read or view). Consequently, many applications or services that use a feed include some type of content selection and relevance logic that is aimed at selecting only the most relevant content to present to a particular member, and then presenting it in order of importance or popularity. In some instances, in selecting and ranking the content items to be presented to a particular member, the relevance logic takes into consideration the inferred or perceived popularity of the content items as measured by the amount and nature of the social activities or social gestures that have occurred in connection with the content items. For example, when a content item is published and presented in a feed, a member may interact with the content item in a variety of ways. A member may “like” the content item, share or re-share the content item, make comments on the content item, select one of several links or hyperlinks associated with the content item, and so forth. These actions are generally referred to as social gestures, and can be used by a relevance algorithm as signals for determining a ranking score for a content item, such that the ranking score will affect how prominently positioned the content item is in a member's feed.

With some feeds, when a member is preparing content to be published, the member is provided an opportunity to promote or sponsor the content. In general, when a member promotes or sponsors a content item, the member agrees to pay a fee in order to manipulate how the relevance algorithm processes the content item. For example, when promoting or sponsoring a content item, the content item may be presented to members who would otherwise not be eligible for viewing the content item, for example, because the members are not associated with (e.g., connected or following) the person or entity on whose behalf the promoted or sponsored content is being published. Accordingly, a company may want to promote or sponsor a content item in order to communicate a message to members, who may not already be following, and thus receiving content items from, the company. Similarly, a content item that is promoted or sponsored may be formatted differently to draw attention to the content item, and/or have its ranking score boosted so that the content item appears in a more prominent position in the feed (e.g., at the top), and so forth.

Many organizations (e.g., companies, schools, government organizations, etc.) have found that posting content to a feed of a social networking application or service can be an effective means of communicating with customers, students, constituents, stakeholders, and so forth. For example, for companies in particular, a feed is a good way of creating brand awareness. However, for a variety of reasons, not all organizations will have members who are experienced with publishing content to a feed, and thus, will not be positioned to take full advantage of the many benefits of this relatively new type of content communication or publishing platform.

### DESCRIPTION OF THE DRAWINGS

Some embodiments are illustrated by way of example and not limitation in the FIG.s of the accompanying drawings, in which:

FIG. 1 is a diagram illustrating an example computer network environment in which a computer-based content communication or publishing platform may be implemented, consistent with embodiments of the present invention;

FIG. 2 is a flow diagram illustrating method operations for a method consistent with some embodiments of the invention and by which a target audience is automatically selected for a content campaign, based on the target audience's likelihood to engage with a content posting in a manner consistent with some member-specified desired objective;

FIG. 3 is a flow diagram illustrating method operations for a method consistent with some embodiments of the invention and by which a content posting is selected based on a determination that a member-specified target audience is likely to engage with the content posting in a manner consistent with some member-specified desired objective;

FIG. 4 is a user interface diagram illustrating an example of a user interface that enables a user of a content publishing platform to specify a desired objective to be achieved with a content campaign, consistent with some embodiments of the invention;

FIG. 5 is a user interface diagram illustrating an example of a user interface that enables a user of a content publishing platform to specify content to be included in a content posting, consistent with some embodiments of the invention;

FIG. 6 is a user interface diagram illustrating an example of a user interface that enables a user of a content publishing platform to specify a target audience to receive in a personalized feed a sponsored content posting, consistent with some embodiments of the invention;

FIG. 7 is a user interface diagram illustrating an example of a user interface for a content posting, including a variety of user interface elements associated with social gestures that can be invoked in connection with the content posting, consistent with some embodiments of the invention; and

FIG. 8 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for use in providing to members of a social networking application or service using a content communication or publishing platform a recommendation regarding a content campaign, wherein the recommendation is meant to aid the member in achieving with the content campaign one of several member-specified objectives. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations, permutations and combinations of the various features and elements described herein.

Skilled artisans will immediately recognize that the inventive subject matter set forth herein will be particularly applicable to computer network-based applications and services that implement a content communication or publishing platform that presents content in the form of a feed or content feed, enabling users to publish and share content with others. This type of content publishing platform is commonly used with a variety of applications and services that include, but are certainly not limited to, social networking services, micro-blogging and blogging services, question-and-answer services, knowledge management applications and services, social enterprise applications, and various other web-based portals. Typically, when a user of one of these applications or services first registers with the application or service, the user will provide certain personal information that becomes part of what is commonly referred to as a member profile. As such, a registered user may generally be referred to herein as a member. However, for purposes of the present document, the term “member” is meant to encompass any user of a particular application or service, consistent with embodiments of the present invention.

Consistent with some embodiments of the invention, a content publishing platform includes a content publishing module that has a user interface enabling a member of a social networking service to provide or otherwise specify some content for publishing (also, commonly referred to as posting) to other members' personalized feeds. In addition to providing or specifying the content to be included in the content posting, the member is prompted to specify or select a desired objective to be achieved with the content posting. For example, the member may desire to maximize the number of followers obtained via the content posting. Alternatively, the member may desire to maximize the viral effect of the content posting by having recipients of the content posting re-share or re-publish the content posting to other members. In other scenarios, the member may simply desire to maximize the number of recipients of the content posting who perform some social action or gesture with respect to the content posting, such as “liking” or up-voting the content posting, which is typically achieved by interacting with a user interface element (e.g., an interactive, user-selectable button or text, labelled as, “like,” “up-vote,” “+1” or with some similar designation.) In yet another example, a member may specify as an objective a desire to maximize or increase content engagement by having members discuss the content posting via a commenting tool or service. These are just some of the example objectives that a content publisher and social networking service participant might specify for a particular content campaign.

Once the member has provided or otherwise specified the content to be included in the content posting, and then selected or otherwise specified the desired objective, a member-targeting optimization module will automatically identify a set of members to whom the content posting should be presented in order to provide the best opportunity to achieve the desired objective. For example, if the desired objective is to increase or maximize the number of members who “like” the content posting, the member-targeting optimization module may identify as preferred recipients of the content posting those members who have previously taken action to “like” or up-vote a previously published content posting that is similar to the current content posting. Similarly, if the desired objective is to increase or maximize the number of members who follow the entity on whose behalf the content is being published, the member-targeting optimization module may identify as preferred recipients of the content posting those members who are most likely to interact with the content posting by taking some action to follow the entity on whose behalf the content posting is being published. For example, the member-targeting optimization module may select as preferred recipients certain members who have recently chosen to follow one or more entities that are known to be similar to the entity on whose behalf the content posting is being published. Accordingly, with some embodiments, given a particular member-specified content posting and a particular member-specified desired objective, the target audience—that is, the members to whom the content is made eligible for presentation—is automatically selected based on a determination that the selected target audience is most likely to take action consistent with the desired objective. In this way, the content publisher need not spend time and energy speculating about which member segments should be targeted to achieve the desired objective. Instead, the content publishing platform will automatically identify the most suitable target audience for the content posting to achieve the member-specified desired objective.

With some embodiments, when a member is specifying parameters for a promoted or sponsored content posting, the member must specify an amount of currency (real or virtual) the member is willing to spend on the campaign. For example, the amount may be specified on a cost-per click or cost-per impression basis. With some embodiments, as impressions occur and the content posting is presented in the personalized feeds of various members that are part of the target audience, the member-targeting optimization module may identify attributes and/or characteristics possessed by those members who are taking action that is consistent with the member-specified desired objective. For example, if the performance data for the partially executed content campaign shows that a particular segment of members in the targeted audience is taking action consistent with the desired objective at a rate that meets or exceeds some threshold measure, the member-targeting optimization module may automatically and dynamically modify the defined target audience, for example, by limiting the target audience to those members who possess the frequently observed attributes and characteristics consistent with, or similar to, the particular segment. For example, if the desired objective is to maximize the number of members who “like” or up-vote the content posting, and the performance data for the partially completed content campaign shows that members having the job title, “Software Engineer,” residing in the San Francisco Bay Area, are “liking” or up-voting the content posting at a rate that exceeds some threshold rate, then the member-targeting optimization module may modify or limit the defined target audience to those members who, according to their member profiles, are residing in the San Francisco Bay Area and have the job title, “Software Engineer.”

Consistent with some embodiments of the invention, a member may specify a target audience for a content posting and specify a desired objective for the content posting, and a content analysis and selection module will automatically select an existing content posting from a variety of existing candidate content postings to be promoted or sponsored by the member, in order to achieve the member-specified desired objective. For example, consistent with some embodiments, a content publishing platform includes a member-targeting module that allows a member who is posting content to designate a target audience for a content posting by specifying various desirable attributes and characteristics of those members to be included in the target audience. For example, the member may specify that the target audience is to consist of those members who, according to their member profiles, possess certain attributes and characteristics (e.g., geographic location, job title, employer, industry, interests, skills, seniority, school attended, field of study, etc.). In addition, the member may specify a desired objective for the content posting. Then, the content analysis and selection module will perform content analysis on a variety of existing content postings to select and recommend a particular content posting to the member that will most likely result in achieving the desired objective. With some embodiments, the candidate content postings may consist of all content items previously posted by the member, or the entity on whose behalf the sponsored content posting is to be published. Alternatively, the candidate content postings may consist of some larger set of content postings, to include certain content postings published by other members and/or entities. With some embodiments, the content analysis may occur in real-time or near real-time, for example, as the member provides the content campaign parameters. However, with some embodiments, the content analysis may be periodically performed to identify relationships and similarities between content postings, and/or the entities on whose behalf content postings are made.

By way of example, if the desired objective is to maximize or increase engagement through member comments made about a sponsored content posting, the content analysis module may identify a particular existing content posting that, when previously published, resulted in a significant number of members making comments about the content posting. Alternatively, the content analysis module may identify one or more content postings published by an entity that has been determined to be similar to the entity on whose behalf the sponsored content posting is being published, and then analyze the one or more content postings of this similar entity to determine the attributes and characteristics of those content postings that members have interacted with in a way that is consistent with the member-specified desired objective. Then, the content analysis module may select a candidate content posting that has the same, or similar, attributes and/or characteristics as those content postings with which members have previously interacted in a way that is consistent with the desired objective. Accordingly, the selected candidate content posting is then recommended to the content publisher as the best content posting to promote or sponsor for achieving the member-specified desired objective.

With some embodiments, the above-described recommendations (i.e., the automatic identification of the best target audience, and/or, the automatic identification of the best content posting, to achieve a desired objective) are provided only in the context of a promoted or sponsored content posting. That is, the content posting recommendations are made when the member (e.g., content publisher) is paying a fee in order to broaden the potential target audience for the content posting to members beyond those with whom the content publisher is already associated (e.g., connected or following), or otherwise manipulating the normal behavior of the relevance algorithm used in selecting and ranking content items presented in the feed. However, with some embodiments, the above-described recommendations may be made for any content posting, including those that are not being sponsored or promoted. Other aspects and advantages of various embodiments of the invention will be readily apparent from the description of the figures that follows.

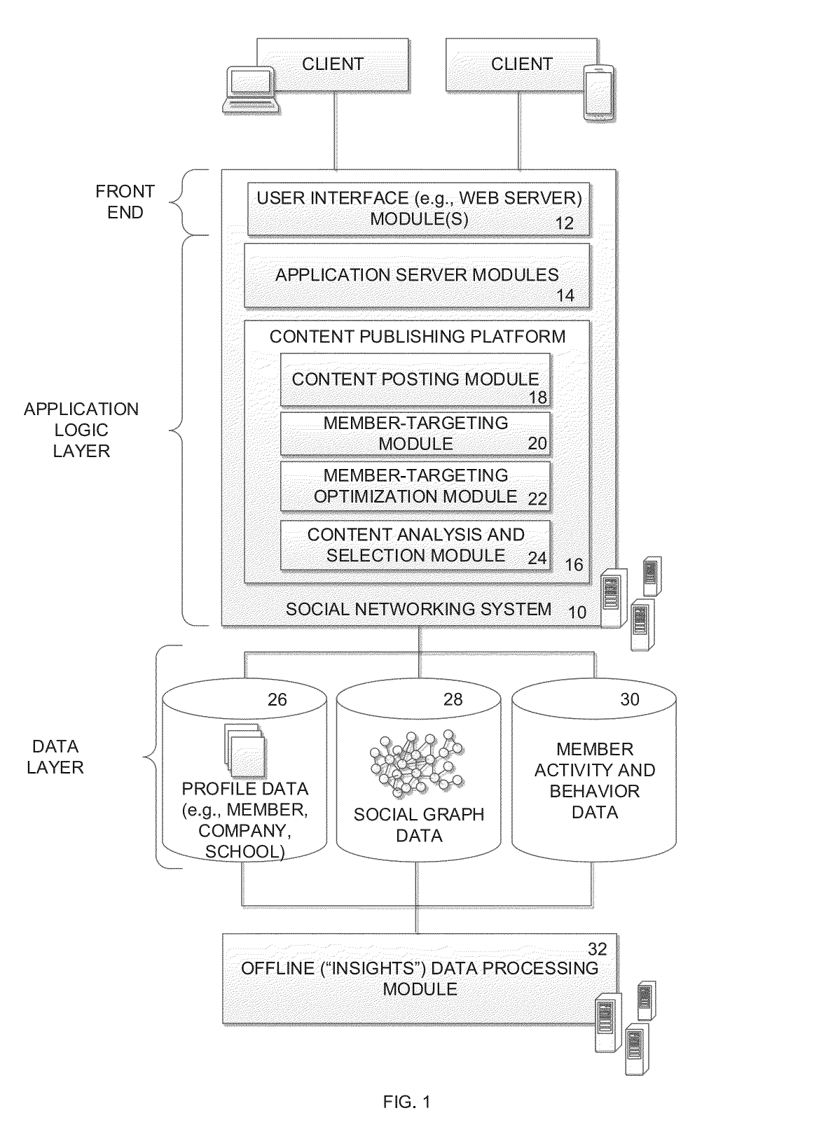

FIG. 1 is a diagram illustrating an example computer network environment in which a computer-based content communication or publishing platform 16 may be implemented, consistent with embodiments of the present invention. As illustrated in FIG. 1, the content publishing platform 16 is part of a social networking system 10. The social networking system 10 includes one or more application server modules 14 that provide any number of applications and services that leverage the social graph data 28 maintained by the social networking system 10. For example, the social networking system 10 may provide a photo sharing application, a job posting and browsing service, a question-and-answer service, and so forth. One or more of these applications or services may leverage the content publishing platform 16 to allow members of the social networking system 10 to generate and publish content via a feed, and thereby share the content with other members of the social networking system 10.

As shown in FIG. 1, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generate various user interfaces (e.g., web pages) with data retrieved from various data sources in the data layer. With some embodiments, individual application server modules 14 are used to implement the functionality associated with various applications, services and/or features of the social networking service. For instance, a social networking service may provide a broad variety of applications and services, to include the ability to search for and browse member profiles, job listings, and news articles. Additionally, applications and services may allow members to share content with one another, for example, via email, messages, and/or content postings (sometimes referred to as status updates) via a feed. With some embodiments, in addition to providing members with the ability to communicate information via the feed, one or more of the applications and services provided by the social networking system 10 may automatically publish content via the content publishing platform 16, that is then presented to members in their respective personalized feeds. For example, in connection with a job posting service, an automated (e.g., system or service-generated) content posting may be generated and communicated to a member to highlight a job that the member may be interested in. A wide variety and number of other applications or services may be made available to members of a social networking service, and will generally be embodied in their own instance of an application server module or modules.

As shown in FIG. 1, the data layer includes several databases, such as a database 26 for storing profile data, including both member profile data as well as profile data for various entities (e.g., companies, schools, and other organizations) represented in the social graph maintained by the social networking service. Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information—generally referred to as member profile information—is stored, for example, in the database with reference number 26. Similarly, when a representative of an organization initially registers the organization with the social networking service, the representative may be prompted to provide certain information about the organization. This information—generally referred to as company profile information—may be stored, for example, in the database with reference number 26 or another database (not shown). With some embodiments, the profile data may be processed (e.g., in the background or offline, by the offline data processing module 32) to generate various derived profile data. For example, if a member has provided information about various job titles the member has held with the same or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another member, the member who is following may receive content postings status updates or other content postings published by the member being followed, or relating to various activities undertaken by the member being followed. Similarly, when a member follows an organization, the member becomes eligible to receive content postings published on behalf of the organization and/or system or service-generated content postings that relate to the organization. For instance, messages or content postings published on behalf of an organization that a member is following will appear in the member's personalized feed. In any case, the various associations and relationships that the members establish with other members, or with other entities and objects, are stored and maintained within the social graph, shown in FIG. 1 with reference number 28.

As members interact with the various applications, services and content made available via the social networking service, the members' behavior (e.g., content viewed, links selected, etc.) may be monitored and information concerning the members' behavior may be stored, for example, as indicated in FIG. 1 by the database with reference number 30. This information may be used to infer a member's intent and/or interests, and to classify the member as being in various categories. For example, if the member performs frequent searches of job listings, thereby exhibiting behavior indicating that the member is a likely job seeker, this information can be used to classify the member as a job seeker. This classification can then be used as a targetable attribute or characteristic for purposes of enabling others to target the member for receiving advertisements, messages or content postings. Accordingly, a company that has available job openings can publish a content posting via the content publishing platform 16 that is specifically directed to certain members of the social networking service who are likely job seekers, and thus, more likely to be receptive to recruiting efforts.

The content publishing platform provides members, as well as applications and services with a communication mechanism for communicating content postings to members. The content posting module 18 operates in conjunction with one or more user interfaces to enable a member to specify content to be published and presented to other members. For example, the content posting module 18 has an associated user interface via which members can specify the particular content that is to be included in a content posting. The member-specified content may be or otherwise include text, file attachments (e.g., photographs, documents, audio or video files, etc.), hyperlinks, and so forth. With some embodiments, when a hyperlink is detected in the specified content, some portion of the particular document of content referenced by the hyperlink may be obtained for inclusion with the content posting.

A member-targeting module 20 has an associated user interface that allows a member to specify a target audience by selecting desirable member attributes and characteristics possessed by those members to be included in the target audience. Under certain circumstances, the member-targeting optimization module 22 automatically identifies an optimal target audience for a particular content campaign or content posting. For example, when a content publisher provides some content and specifies a desired objective, the member-targeting optimization module 22 identifies a target audience that will most likely act consistent with the desired objective. For instance, with some embodiments, the member-targeting optimization module 22 will obtain attributes and characteristics of the content posting that is to be published, and then identify one or more similar content postings that have been made by an entity similar to the entity on whose behalf the content posting is being published. These similar content postings are then analyzed to identify the attributes and characteristics of the members who interacted with these similar content postings in a manner consistent with the desired objective. Finally, the member-targeting optimization module 22 will identify members who possess the same, or similar, attributes and characteristics as those possessed by the members who took action on a similar content posting, where such action was consistent with the member-specified desired objective.

With some embodiments, the member-targeting optimization module 22 will analyse an active content campaign in order to identify specific member attributes and characteristics that are possessed by members who are acting with respect to a content posting in a manner consistent with the desired objective. As such, the member-targeting optimization module 22 may identify a certain segment of the target audience that is more frequently acting consistent with the desired objective than some other segments of the target audience. Accordingly, the member-targeting optimization module may fine-tune or otherwise narrow the target audience to include members who possess the particular member attributes and characteristics that are commonly possessed by those members who have already acted consistently with the desired objective.

The content publishing platform 16 includes a content analysis and selection module 24. In certain scenarios, for example, when a member has specified a desired objective and a target audience, the content analysis and selection module 24 identifies the best content posting the member can select to promote or sponsor to achieve the member's desired objective. For example, when a member manually selects the target audience and a desired objective, the content analysis and selection module may identify previously published content postings with which members of the member-specified target audience have previously interacted in some manner that was consistent with the member-specified desired objective. Then, attributes and characteristics of the content postings that the target audience interacted with in a manner consistent with the desired objective are identified. These attributes and characteristics are then compared with the attributes and characteristics of various candidate content postings, such that, a candidate content posting that has the most similarity with a previously published content posting that achieved the desired objective is selected.

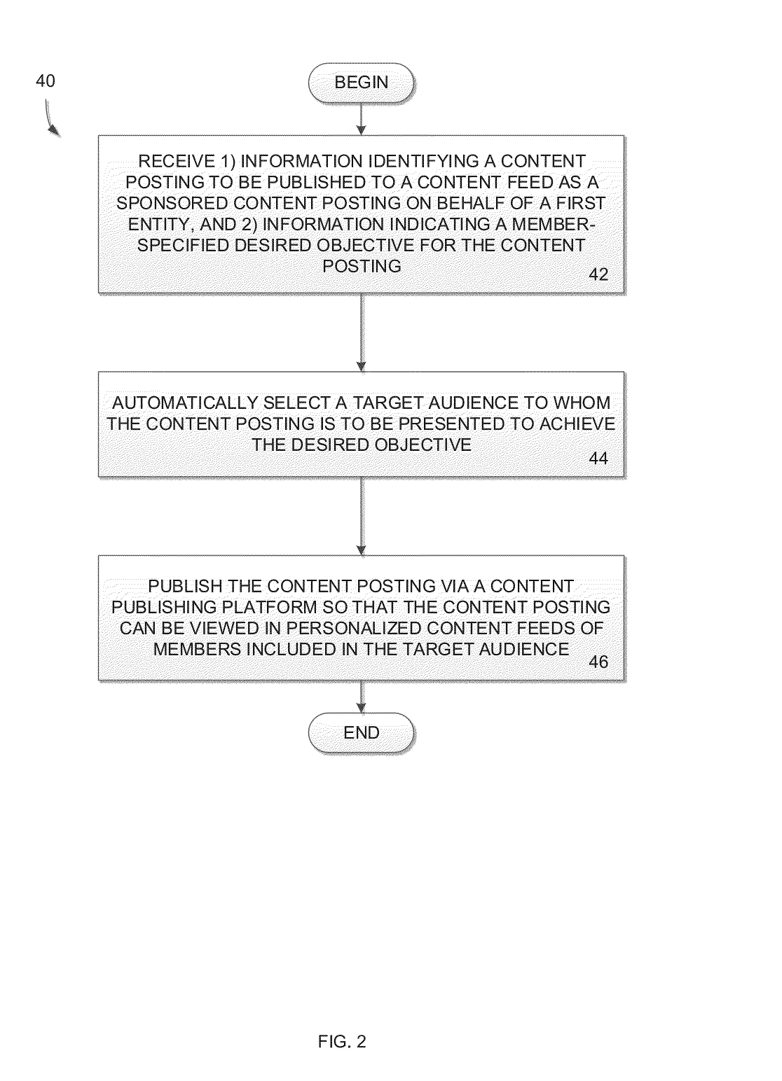

FIG. 2 is a flow diagram illustrating method operations for a method 40 consistent with some embodiments of the invention and by which a target audience is automatically selected for a content campaign, based on the target audience's likelihood to engage with a content posting in a manner consistent with some member-specified desired objective. As illustrated in FIG. 2, consistent with some embodiments, through a user interface associated with a content posting module, a member specifies some content to be included in a sponsored content posting that is to be published via a feed to various members of a social networking service or application. The member may elect to promote or sponsor a previously posted content item, or alternatively, the member may specify some new content to be included in a sponsored content posting. In addition, the member may select or otherwise specify a desired objective to be achieved with the content posting. As such, at method operation 42, the content posting module will receive some information identifying or otherwise specifying a content posting to be published on behalf of an entity, and information indicating a desired objective for the content posting.

With some embodiments, several desired objectives may be presented to the member for selection. By way of example, the system may prompt the member to select from the following desired objectives: maximize the number of members who “like” the content posting; maximize the number of members who re-share the content posting; maximize the number of members who comment on the content posting; maximize the number of members who elect to follow the entity on whose behalf the content posting is being published, and; maximize the number of members who select a link to a third-party hosted web page.

Next, at method operation 44, a member-targeting optimization module automatically selects a target audience to whom the content posting is to be presented to achieve the desired objective. For example, with some embodiments, the member-specified content posting is analyzed to identify its most prominent attributes and characteristics (e.g., subject matter, etc.). In addition, attributes and characteristics of the entity on whose behalf the content posting is to be published are also identified. These attributes and characteristics are then used to identify previously published content postings that members engaged with in a manner consistent with the member-specified desired objective. With some embodiments, the members who interacted with similar content postings in a manner consistent with the desired objective are selected for inclusion in the target audience. Alternatively, the most commonly occurring attributes and characteristics of these members (i.e., the members who interacted with a similar content posting in a manner consistent with the desired objective) may be identified, so that members having these frequently observed attributes and characteristics can be included in the target audience.

Finally, once the target audience has been selected, at method operation 46 the content posting is published via the content publication platform so that the content posting can be viewed in the personalized content feeds of those members included in the target audience. For example, when a member included in the target audience views his or her feed, the content publishing platform will select the content posting to present to the member.

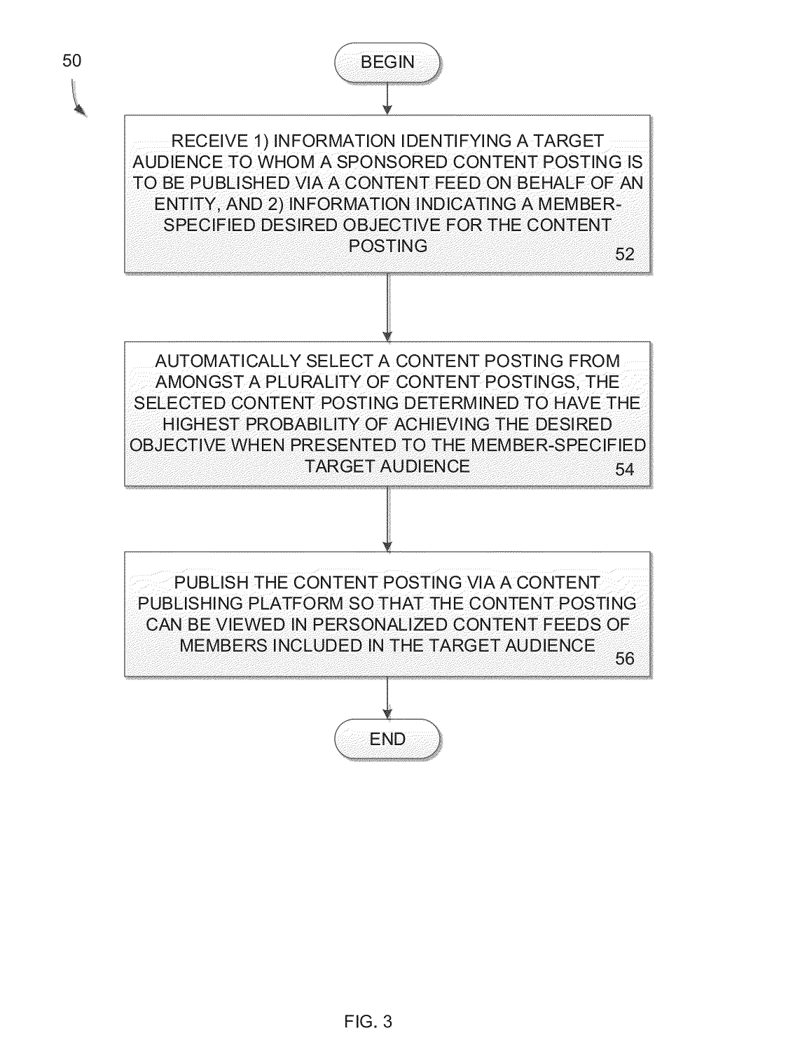

FIG. 3 is a flow diagram illustrating method operations for a method 50 consistent with some embodiments of the invention and by which a content posting is automatically selected based on a determination that a member-specified target audience is likely to engage with the content posting in a manner consistent with some member-specified desired objective. In contrast with the method presented in FIG. 2, a member specifies a target audience and a desired objective in the method of FIG. 3. Accordingly, the method begins at method operation 52 when a member targeting module receives information specifying a target audience, and a content posting module receives information identifying a member-specified desired objective. Then, at method operation 54, a content analysis and selection module will automatically select a content posting from amongst several candidate content postings. The candidate content posting that is selected as the content posting that is recommended to promote or sponsor is the content posting most similar to other content postings (e.g., based on content attributes and characteristics, as well as entity attributes and characteristics) that the member-specified target audience previously interacted with in a manner consistent with the member-specified desired objective. Finally, at method operation 56, the content posting is published via the content publishing platform so that the content posting is available for presentation in the personalized feeds of those members targeted by the content publisher.

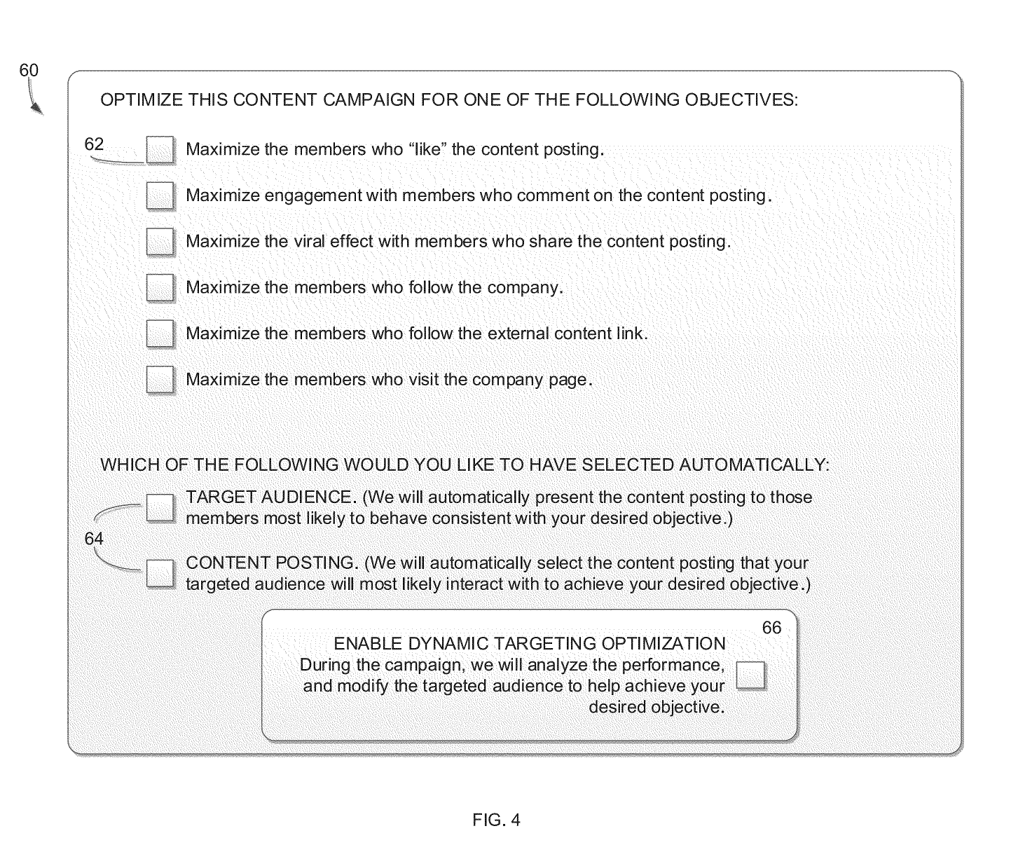

FIG. 4 is a user interface diagram illustrating an example of a user interface 60 that enables a user of a content publishing platform to specify a desired objective to be achieved with a content campaign, consistent with some embodiments of the invention. As illustrated in FIG. 4, when a member is promoting or sponsoring a content posting—whether it be a content posting that the member previously published, or a new content posting—the member may elect to specify a desired objective for the content posting. In particular, the member may desire to maximize some particular type of social gesture that members take with respect to the content posting. For instance, as illustrated in FIG. 4, a member may select any of several desired objectives by simply checking a box, such as the box with reference number 62.

In addition, as illustrated by the boxes with reference number 64, the member may opt to allow the content publishing module to automatically identify the target audience that will best achieve the desired objective, or may allow the content publishing platform to automatically select the content posting that is to be sponsored to achieve the desired objective. In addition, as shown with reference number 66, the member may opt in to a dynamic targeting optimization feature that will modify the target audience during the content campaign, based on performance, in an attempt to achieve the desired objective.

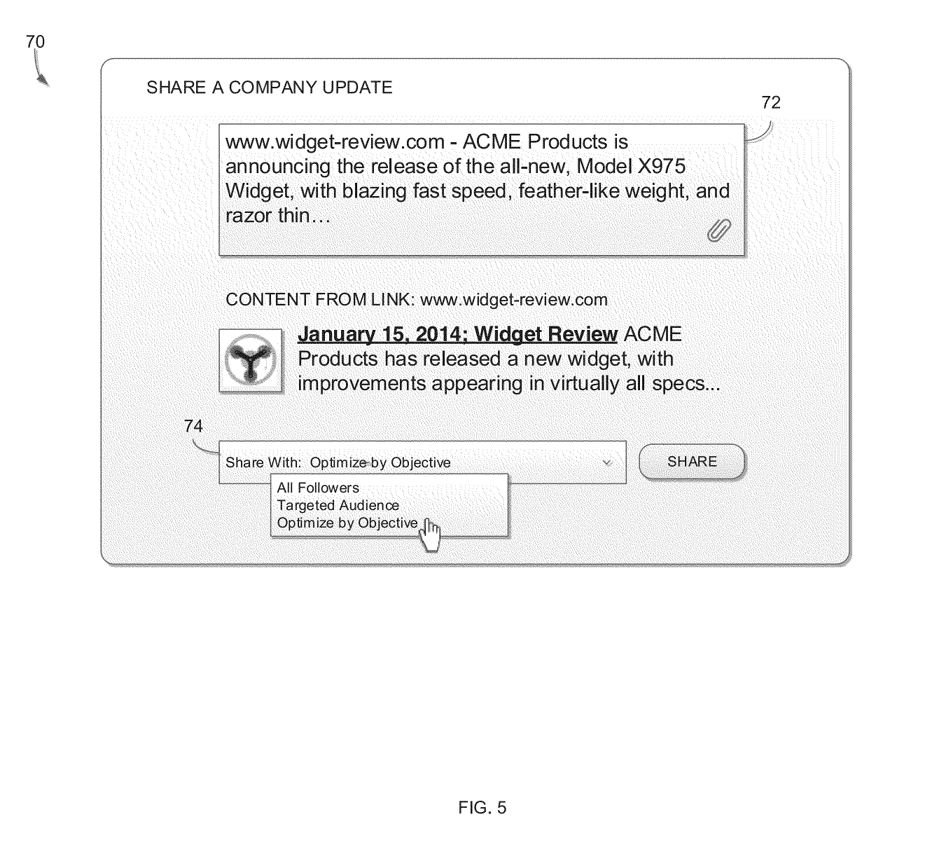

FIG. 5 is a user interface diagram illustrating an example of a user interface 70 that enables a user of a content publishing platform to specify content to be included in a content posting, consistent with some embodiments of the invention. As illustrated in FIG. 5, the content posting module interface 70 includes a text input box 72 for receiving content to be included in a content posting. Via the text input box 72, a member can specify a link, and the system will automatically obtain the information referenced by the link and include it with the content posting. In addition, a member may include an attachment (e.g., a file, document, video, etc.) to be included with the content posting. Finally, via the drop-down box 74, the member may specify a particular segment of members as the target audience. If the member has previously elected to have the target audience automatically selected (e.g., by a member-targeting optimization module), the drop-down box 74 may not be shown, or may default to the pre-selected option (e.g., “optimize by objective”).

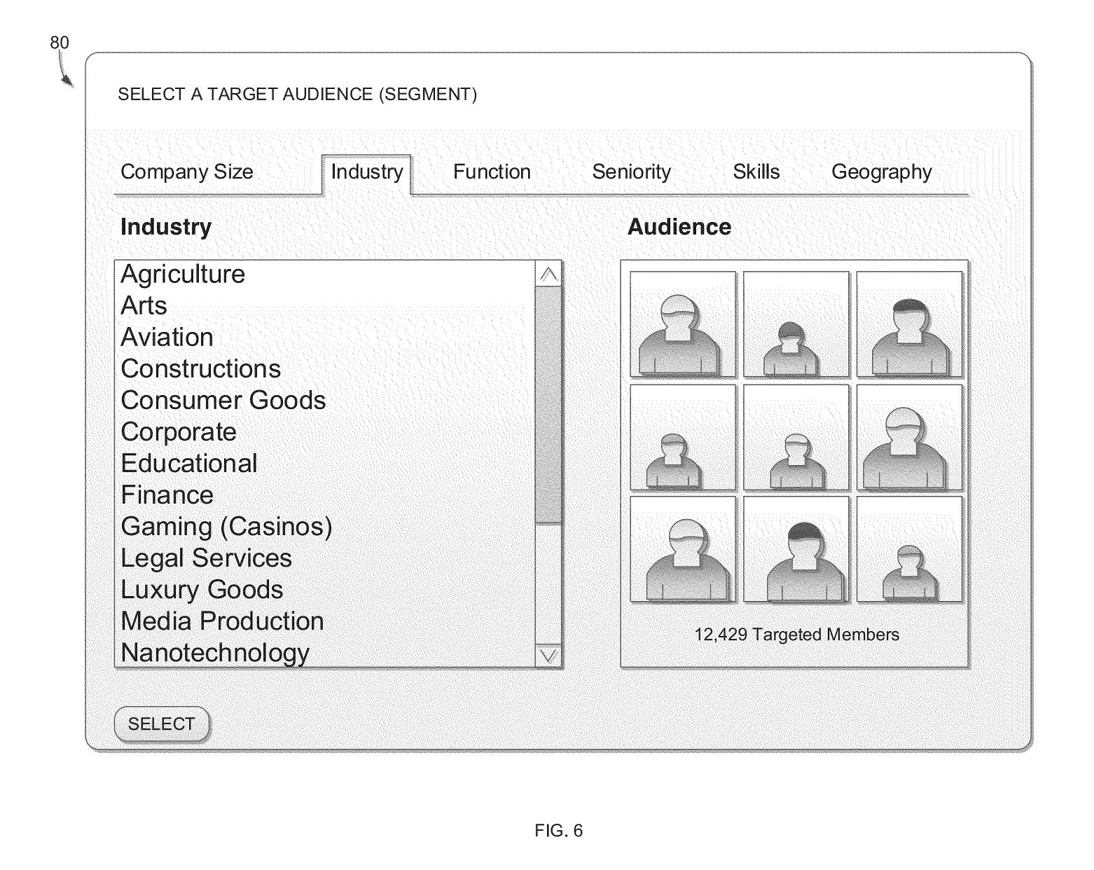

FIG. 6 is a user interface diagram illustrating an example of a member-targeting interface 80, which enables a member to specify the attributes and/or characteristics that define a segment of the population of members of a social networking service who are to be selected for the presentation of a content posting, consistent with some embodiments. For example, the member-targeting interface may be an interface that operates in conjunction with the member-targeting module presented in FIG. 1. As illustrated in FIG. 6, the member-targeting interface 80 allows a member to define the member targeting criteria for a content posting by simply selecting from a wide variety and number of member attributes and characteristics. Specifically, by selecting a set of attributes and characteristics as member targeting criteria, a member is requesting that the content posting only be served to members who have or possess the selected attributes and characteristics. Accordingly, a member who is part of an organization that develops, manufactures and sells hardware devices for computer networking may want to target members of the social networking service who work in select industries, at companies of a particular size, and have a job function relating to, for example, information technology.

In the example of FIG. 6, the targeting criteria include attributes and characteristics in the categories, “Company Size,” “Industry,” “Function,” “Seniority,” “Skills,” and “Geography.” For each category, there are numerous attributes from which to select. For example, within the category tab for the category, “Industry”, the specific attributes include such industries as “Agriculture,” “Arts,” “Aviation” and so on. Of course, the interface shown in FIG. 6 is presented merely as an example, and any number and variety of other attributes and characteristics not specifically presented in the interface of FIG. 6 are applicable to the inventive subject matter. Specifically, with some embodiments, members may be classified into one or more of a wide variety of groups, based on information or data signals that may be explicit (e.g., a member profile attribute) or inferred, for example, from a pattern of exhibited behaviors, or, from information relating to a member's connections. For example, with some embodiments, a member may be targeted based on that member being classified as a job-seeker, or, a recruiter, and so forth.

By selecting a set of attributes and characteristics for use as member targeting criteria for a content posting, a member is defining a segment—that is, a set of members of the social networking service who have attributes satisfying the member targeting criteria. In the example of FIG. 6, a portion of the member-targeting interface displays a summary view of the targeted segment (e.g., potential audience), based on the currently selected member targeting criteria. In this example, in addition to showing the total number of members in the targeted segment (e.g., “12,429 Targeted Members”), the profile pictures of several of the members in the segment are also presented. Of course, using the member-targeting interface, a content publisher may establish several different segments as being eligible to receive and view a particular content posting.

With some embodiments, a member is provided with the option of using the member-selected member targeting criteria for the entire duration of the content campaign, or alternatively, electing to use a dynamic targeting optimization scheme by which the targeting criteria will be automatically modified over time during the content campaign, with a view to achieving some member-specified objective. With some embodiments, the dynamic targeting optimization scheme may be used with all campaigns by default. In yet other embodiments, other user interface elements may be presented to allow an advertiser to provide various input information to establish parameters or configuration settings by which the dynamic targeting scheme will operate for the particular advertising campaign. For example, with some embodiments, a content publisher may provide a parameter to indicate how aggressively new or alternative targeting criteria should be tested—in essence, establishing the number or percentage of impressions for which modified targeting criteria may be used to test alternative targeted segments.

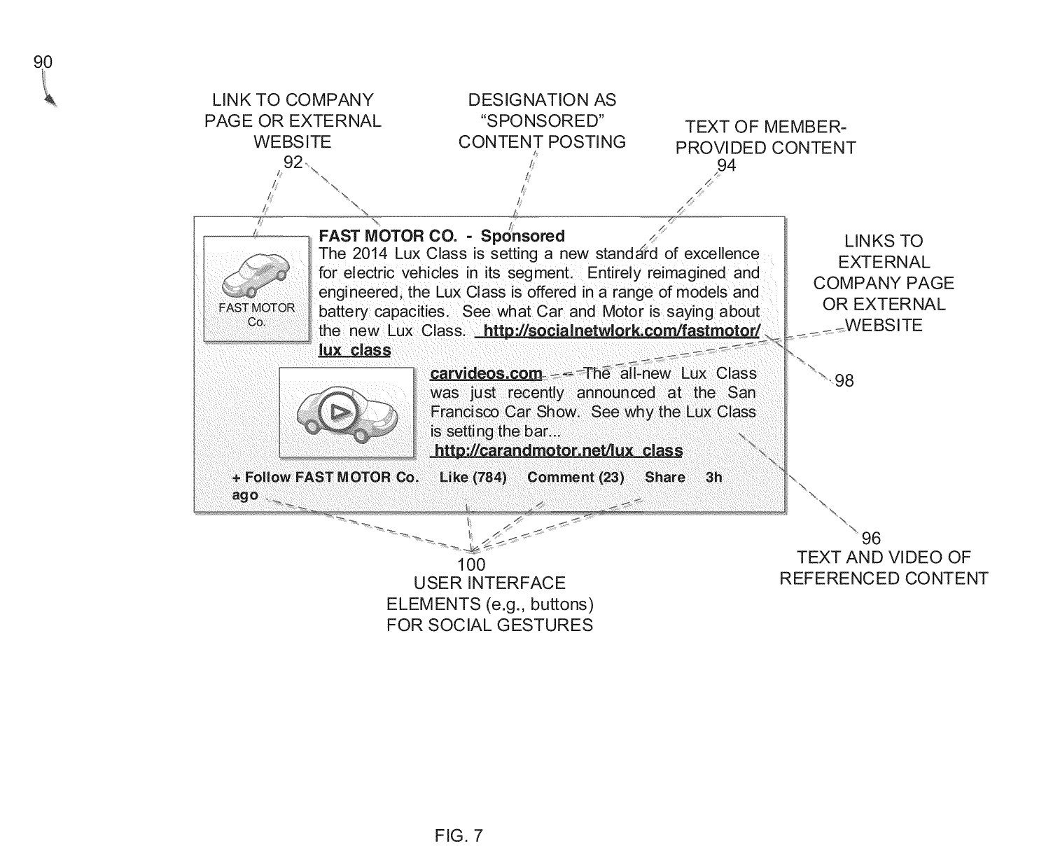

FIG. 7 is a user interface diagram illustrating an example of a user interface 90 for a content posting, including a variety of user interface elements associated with social gestures that can be invoked in connection with the content posting, consistent with some embodiments of the invention. As shown in FIG. 7, the sponsored content posting 90 includes one or more links 92 to a company page that is hosted by the social networking service. In addition, the sponsored content posting includes the text 94 that has been provided by the member, as well as information 96 referenced by a hyperlink 98 specified by the member. Finally, the sponsored content posting includes a variety of user interface elements (e.g., buttons or links) 100 that facilitate social gestures. For example, a member viewing the content posting might elect to follow the entity on whose behalf the content has been posted, “like” the content posting, comment on the content posting, or share the content posting with others. With some embodiments, the exact social gestures available, and their position within the content posting, may depend upon the desired objective specified by the content publisher. For example, if the desired objective is to increase or maximize the members who “like” the content posting, the “like” button may be more prominently displayed (in terms of size, color, and position).

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

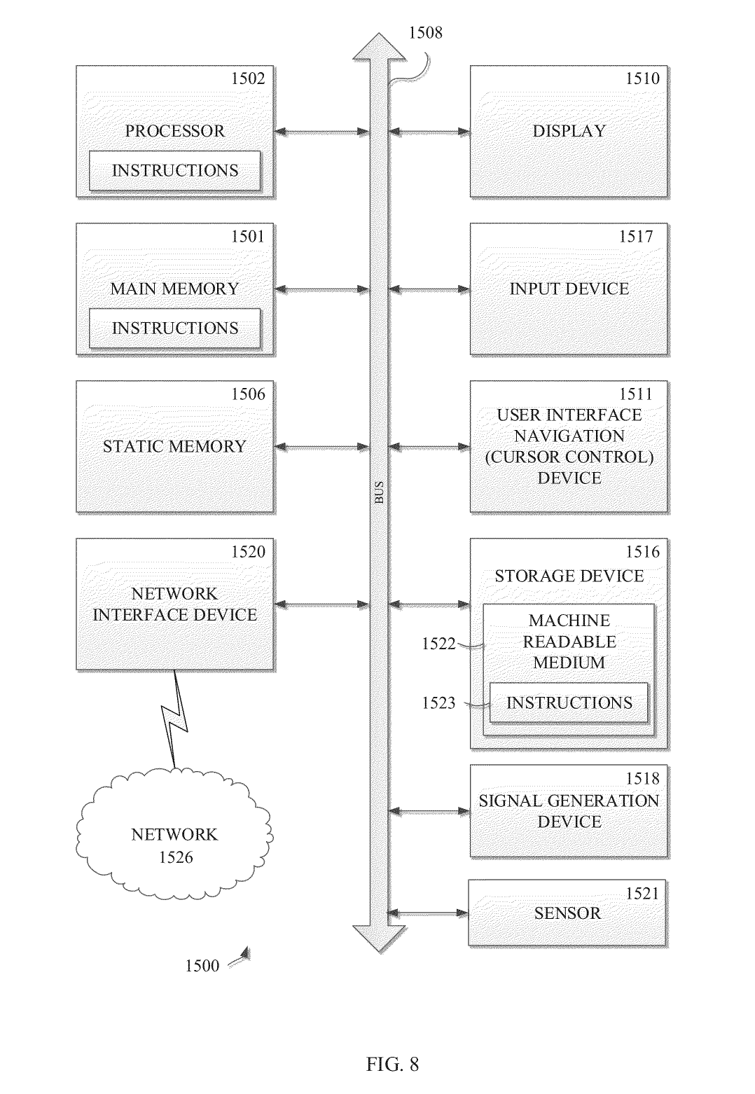

FIG. 8 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method comprising:
receiving information identifying a content posting to be published to a content feed as a sponsored content posting on behalf of a first entity;
receiving information indicating a desired objective for the content posting;
with a processor-implemented member-targeting optimization module, automatically selecting a recommended target audience to whom the content posting is to be presented to achieve the desired objective; and
publishing the content posting via a content publishing platform so that the content posting can be viewed in personalized content feeds of members of the recommended target audience.

2. The method of claim 1, wherein receiving information indicating a desired objective for the content posting comprises:
causing a plurality of user-selectable desired objectives for the content posting to be presented; and
receiving information indicating a selection of one of the plurality of desired objectives for the content posting, the plurality of desired objectives selected from the group consisting of: i) maximizing the number of members who “like” the content posting, ii) maximizing the number of members who re-share the content posting, iii) maximizing the number of members who comment on the content posting, iv) maximizing the number of members who elect to follow the entity on whose behalf the content posting has been published, and v) maximizing the number of members who select a link to a third-party hosted web page.

3. The method of claim 1, wherein automatically selecting the recommended target audience comprises:
analyzing the content posting to identify a topic to which subject matter of the content posting relates;
identifying one or more previous content postings with subject matter related to the same topic to which the subject matter of the content posting relates; and
selecting for inclusion in the recommended target audience one or more members of the social networking service who interacted with the previous content posting in a manner that is consistent with the desired objective.

4. The method of claim 3, wherein identifying one or more previous content postings with subject matter related to the same topic to which the subject matter of the content posting relates, comprises:
identifying one or more previous content postings posted by a second entity other than the first entity, the second entity sharing in common one or more attributes with the first entity, the one or more attributes selected from the group: entity size, industry of entity, location of entity, revenue of entity, and age of entity.

5. The method of claim 1, wherein automatically selecting the recommended target audience comprises:
analyzing the content posting to identify a topic to which subject matter of the content posting relates;
identifying one or more previous content postings with subject matter related to the same topic to which the subject matter of the content posting relates;
identifying one or more member profile attributes possessed by members of the social networking service who interacted with the previous content posting in a manner that is consistent with the desired objective; and
selecting for inclusion in the recommended target audience one or more members of the social networking service who are following the first entity and who possess the identified one or more member profile attributes.

6. The method of claim 1, wherein automatically selecting the recommended target audience comprises:
performing content analysis on the content posting to compare the content posting with one or more previously published content postings; and
identifying one or more of the previously published content postings having a similarity score that exceeds a threshold; and
selecting for inclusion in the recommended target audience one or more members of the social networking service who interacted with at least one of the one or more previously published content postings having the similarity score that exceeds the threshold in a manner that is consistent with the desired objective.

7. The method of claim 1, wherein the desired objective is to maximize the number of members who, when presented with the content posting, elect to re-share the content posting, the method further comprising:
determining the content posting is similar to one or more previously published content postings; and
selecting for inclusion in the recommended target audience one or more members of the social networking service who interacted with at least one of the one or more previously published content postings by re-sharing the at least one previously published content posting.

8. The method of claim 1, wherein the desired objective is to maximize the number of members who, when presented with the content posting, elect to follow the first entity on whose behalf the content posting is being published, the method further comprising:
determining the content posting is similar to one or more previously published content postings; and
selecting for inclusion in the recommended target audience one or more members of the social networking service who interacted with at least one of the one or more previously published content postings by electing to follow the entity on whose behalf the at least one previously published content postings was published.

9. A data processing system having a processor for executing instructions stored in memory, the instructions, when executed, providing a content publishing platform comprising:
a content posting module to receive information identifying a content posting to be published to a content feed as a sponsored content posting on behalf of a first entity, and information indicating a desired objective for the content posting; and
a member-targeting optimization module to automatically select a recommended target audience to whom the content posting is to be presented to achieve the desired objective;
wherein the content posting module is configured to publish the content posting via the content publishing platform so that the content posting can be viewed in personalized content feeds of members of the automatically selected recommended target audience.

10. The data processing system of claim 9, wherein the content posting module is to i) cause a plurality of user-selectable desired objectives for the content posting to be presented, and ii) receive information indicating a selection of one of the plurality of desired objectives for the content posting, the plurality of desired objectives selected from the group consisting of: i) maximizing the number of members who “like” the content posting, ii) maximizing the number of members who re-share the content posting, iii) maximizing the number of members who comment on the content posting, iv) maximizing the number of members who elect to follow the entity on whose behalf the content posting has been published, and v) maximizing the number of members who select a link to a third-party hosted web page.

11. The data processing system of claim 9, wherein the content publishing platform further comprises:
a content analysis module to i) analyze the content posting to identify a topic to which subject matter of the content posting relates, and ii) identify one or more previous content postings with subject matter related to the same topic to which the subject matter of the content posting relates;
wherein the member-targeting optimization module is to select for inclusion in the recommended target audience one or more members of the social networking service who interacted with the previous content posting in a manner that is consistent with the desired objective.

12. The data processing system of claim 11, wherein the content analysis module is configured to identify one or more previous content postings posted by a second entity other than the first entity, the second entity sharing in common one or more attributes with the first entity, the one or more attributes selected from the group: entity size, industry of entity, location of entity, revenue of entity, and age of entity.

13. The data processing system of claim 9, wherein the content analysis module is configured to i) analyze the content posting to identify a topic to which subject matter of the content posting relates, and ii) identify one or more previous content postings with subject matter related to the same topic to which the subject matter of the content posting relates, the member-targeting optimization module is configured to i) identify one or more member profile attributes possessed by members of the social networking service who interacted with the previous content posting in a manner that is consistent with the desired objective, and ii) select for inclusion in the recommended target audience one or more members of the social networking service who are following the first entity and who possess the identified one or more member profile attributes.

14. The data processing system of claim 9, wherein the content publishing platform further comprises:
a content analysis module to i) perform content analysis on the content posting to compare the content posting with one or more previously published content postings, and ii) identify one or more of the previously published content postings having a similarity score that exceeds a threshold;
wherein the member-targeting optimization module is to select for inclusion in the recommended target audience one or more members of the social networking service who interacted with at least one of the one or more previously published content postings having the similarity score that exceeds the threshold in a manner that is consistent with the desired objective.

15. The data processing system of claim 9, wherein the desired objective is to maximize the number of members who, when presented with the content posting, elect to re-share the content posting, the content publishing platform to i) determining the content posting is similar to one or more previously published content postings, and ii) select for inclusion in the recommended target audience one or more members of the social networking service who interacted with at least one of the one or more previously published content postings by re-sharing the at least one previously published content posting.

16. The data processing system of claim 9, wherein the desired objective is to maximize the number of members who, when presented with the content posting, elect to follow the first entity on whose behalf the content posting is being published, the content publishing platform to determine the content posting is similar to one or more previously published content postings, and ii) select for inclusion in the recommended target audience one or more members of the social networking service who interacted with at least one of the one or more previously published content postings by electing to follow the entity on whose behalf the at least one previously published content postings was published.

17. A non-transitory computer readable storage medium storing instructions, which, when executed by a processor of a server computer, cause the server computer to perform operations comprising:
receiving information identifying a content posting to be published to a content feed as a sponsored content posting on behalf of a first entity,
receiving information indicating a desired objective for the content posting; with a processor-implemented member-targeting optimization module, automatically selecting a target audience to whom the content posting is to be presented to achieve the desired objective; and
publishing the content posting via a content publishing platform so that the content posting can be viewed in personalized content feeds of members of the target audience.

18. The non-transitory computer readable storage medium of claim 17 storing further instructions, which, when executed by a processor of a server computer, cause the server computer to perform operations comprising:
causing a plurality of user-selectable desired objectives for the content posting to be presented; and
receiving information indicating a selection of one of the plurality of desired objectives for the content posting, the plurality of desired objectives selected from the group consisting of: i) maximizing the number of members who “like” the content posting, ii) maximizing the number of members who re-share the content posting, iii) maximizing the number of members who comment on the content posting, iv) maximizing the number of members who elect to follow the entity on whose behalf the content posting has been published, and v) maximizing the number of members who select a link to a third-party hosted web page.

19. The non-transitory computer readable storage medium of claim 17 storing further instructions, which, when executed by a processor of a server computer, cause the server computer to perform operations comprising:
analyzing the content posting to identify a topic to which subject matter of the content posting relates;
identifying one or more previous content postings with subject matter related to the same topic to which the subject matter of the content posting relates; and
selecting for inclusion in the target audience one or more members of the social networking service who interacted with the previous content posting in a manner that is consistent with the desired objective.

20. The non-transitory computer readable storage medium of claim 17 storing further instructions, which, when executed by a processor of a server computer, cause the server computer to perform operations comprising:
identifying one or more previous content postings posted by a second entity other than the first entity, the second entity sharing in common one or more attributes with the first entity, the one or more attributes selected from the group: entity size, industry of entity, location of entity, revenue of entity, and age of entity.
